(19) United States
(12) Patent Application Publication
(10) Pub. No.: US 2024/0203187 A1
(43) Pub. Date: Jun. 20, 2024

(54) APPARATUS AND METHOD FOR CHECKING VALUE DOCUMENTS AND SYSTEM FOR PROCESSING VALUE DOCUMENTS

(71) Applicant: GIESECKE+DEVRIENT CURRENCY TECHNOLOGY GMBH, Munchen (DE)

(72) Inventors: Manfred GEBHARDT, Eching (DE); Norbert HOLL, Germering (DE); Shkelqim SHALA, Geretsried (DE); Dieter STEIN, Holzkirchen (DE)

(21) Appl. No.: 18/555,146

(22) PCT Filed: Apr. 7, 2022
(86) PCT No.: PCT/EP2022/025137

§ 371 Date: Oct. 12, 2023

(30) Foreign Application Priority Data
Apr. 14, 2021 (DE) 10 2021 001 963.6

(51) Int. Cl. G07D 7/206; G07D 11/50

(52) U.S. Cl. CPC G07D 7/206; G07D 11/50; G07D 2207/00; G07D 2211/00

(57) ABSTRACT

An apparatus for checking value documents, more particularly banknotes, includes at least one image-capturing device, which is designed to capture at least one image of each of a plurality of value documents. The images are each composed of a plurality of pixels. The apparatus includes an evaluation device, which is designed to determine, in the captured images of different value documents, one or more positions of pixels at which a plurality of the captured images of the different value documents deviate from a predefined reference image. A method and a system correspond to the apparatus for processing value documents.

The invention relates to an apparatus and a method for checking value documents, and more particularly banknotes, and a system for processing value documents.

In banknote production, the freshly-printed banknotes are subjected to automatic checking for quality assurance in which captured images of the banknotes are compared to the images of corresponding reference banknotes. If the image of a banknote deviates from the image of the corresponding reference banknote in a specified manner, this banknote is classified as defective or “unfit,” is output into a corresponding sorting compartment, and is subjected to subsequent manual or visual inspection by an operator.

It is an object of the invention to specify an apparatus and a method for checking value documents, and more particularly banknotes, as well as a system for processing value documents which enables an improved detection of errors in banknotes—more particularly in connection with quality assurance during banknote production.

This object is achieved by an apparatus and a method for checking value documents, and more particularly banknotes, according to the independent claims, and a system for processing value documents with such an apparatus.

An apparatus for checking value documents, and more particularly banknotes, according to a first aspect of the invention has at least one image-capturing device, which is designed to capture at least one image of each of a plurality of value documents, said images being composed of a plurality of pixels, and is characterized by an evaluation device which is designed to determine, in the captured images of different value documents, one or more positions of pixels at which a plurality of the captured images of the different value documents deviate from a predefined reference image.

A system for processing value documents, and more particularly banknotes, according to a second aspect of the invention has at least one apparatus for processing, and more particularly marshaling, conveying, and/or sorting, value documents and at least one apparatus for checking value documents according to the first aspect of the invention.

In a method for checking value documents, and more particularly banknotes, according to a third aspect of the invention, at least one image of each of a plurality of value documents is captured, said images being composed of a plurality of pixels. In the images captured from different value documents, one or more positions of pixels are determined at which a plurality of the captured images of the different value documents deviate from a predefined reference image.

A computer program product according to a fourth aspect of the invention comprises commands which, when the program is executed by a computer, cause the computer to carry out the method according to the third aspect of the invention.

A computer-readable storage medium according to a fifth aspect of the invention comprises commands which, when executed by a computer, cause the computer to carry out the method according to the third aspect of the invention.

Aspects of the invention are preferably based upon the approach of analyzing the captured images of a plurality of different value documents with respect to any deviations from a reference image which occur in a plurality of the checked value documents or occur repeatedly or recurrently in the case of a successive check of the individual value documents. On the basis of possible deviations of individual value document images from the reference image, it is therefore not only possible to infer a possible error or defect in the appearance of a single value document; rather, in addition, errors or defects occurring in the appearance of the checked value documents can be detected frequently or repeatedly or recurrently, which errors or defects are also referred to as “uniform errors” or “recurring errors” in connection with the present disclosure.

Such uniform errors can, for example, be errors or defects which occur frequently or recurrently at certain locations of the print image and/or with respect to the dimension and/or shape of the value documents and on the basis of which it is possible to deduce possible errors in the production—for example, in the printing, cutting, and/or transport—of the value documents. However, the uniform errors can also be errors or defects which are frequently or repeatedly determined during the checking of the value documents, and more particularly during the comparison of the respectively captured images to the corresponding reference images, but do not occur at all or do not occur in a sufficiently pronounced manner in the print image or in the dimension and/or shape of the relevant value document; on the basis of such uniform errors, it is then possible to deduce any errors in the checking of the value documents—for example, in the checking software and/or in the image capture.

Whereas uniform errors rejected as “unfit” during a manual or visual post-processing of value documents can be recognized only in rare cases, even by well-trained operating personnel, the invention makes it possible to identify uniform errors automatically, and thus reliably and quickly, so that any possible causes during production and/or downstream checking of the value documents can be identified and eliminated quickly and reliably. The production of rejects in the form of further value documents having such uniform errors can thereby be significantly reduced. Furthermore, during a checking of the value documents produced after a corresponding adaptation of the production process or during a checking of value documents carried out after a (post-) adaptation of the checking software, the proportion or the rate of value documents classified as “unfit” and to be subjected to a manual or visual post-processing by an operator due to production errors or errors occurring during the checking is significantly reduced, as a result of which the efficiency of the checking process downstream of the production of the value documents is also increased.

Overall, the invention improves the recognition of errors in value documents, such that—especially with applications in connection with quality assurance—both the production and the checking of value documents downstream of the production can be improved.

Preferably, the evaluation device is designed to determine, from the captured images of each of the different value documents, an error image, which is also referred to as a “defective image” in connection with the present disclosure, and which contains one or more error pixels at the positions of which the captured image of the respective value document deviates from the reference image, and to determine from the error images a repetition error image or a deviation image, which is also referred to in conjunction with the present disclosure as a “heat map” and contains one or more deviation pixels, the positions of which correspond to the positions of error pixels at which a plurality of the captured images of the different value documents deviate from the reference image. For example, the pixel values of the individual error pixels can be determined by means of subtraction or division from the pixel values of the corresponding pixels of the respectively captured image and the reference image. In the error image, corresponding pixel values—more particularly in the form of grayscale values—can then be assigned either to all pixel positions or else only to those pixel positions in which the deviation of the captured image from the reference image exceeds a certain magnitude. In the latter case, the pixel values of the error pixels can be specified in the form of grayscale values, but a corresponding error image can also be a binary image in which the value 1 is assigned to the error pixels, and the value 0 is assigned to all other pixels. From the error images obtained for the different value documents, a repetition error image is determined—preferably by means of statistical methods for analyzing time and/or data sets—the deviation pixels of which mark or indicate those positions in which the captured images of the different value documents frequently or repeatedly deviate from the reference image. Preferably, the evaluation device is designed to determine a deviation pixel value for each of the deviation pixels, taking into account a frequency with which the corresponding positions of error pixels are contained in the error images. In the simplest case, the repetition error image can be a binary image in which the deviation pixel value 1 is assigned to the deviation pixels, and the value 0 is assigned to all other pixels. In this case, the repetition error image contains a qualitative statement as to where in the captured images deviations frequently or repeatedly occur. Preferably, the repetition error image is a grayscale image in which at least the deviation pixels are each assigned grayscale values which represent a measure of the frequency of the occurrence of deviations at the relevant positions of the captured images, so that, in addition to a qualitative statement on the position, a quantitative statement about the frequency of the uniform errors is also made. In particular, the repetition error image shows recurring errors of the respective defective images.

Preferably, the evaluation device is designed to determine a deviation pixel value for the deviation pixels by means of exponential smoothing and/or by forming a sliding average from the error pixels contained in the error images. In both methods, the individual pixels or pixel values of the error images, which are determined from the successively captured images of different value documents, are considered time or data sets which are smoothed by weighting the individual pixel values. In the case of exponential smoothing, pixels with increasing timeliness (i.e., error images from the last captured images of value documents) obtain a higher weighting than pixels with lower timeliness (i.e., error images of images which were recorded at earlier points in time). When a sliding average value is formed, smoothing is accomplished by removing higher frequency components. As a result of these analysis methods, uniform errors which occur frequently or repeatedly can be determined in a particularly simple and reliable manner.

Preferably, the evaluation device is designed to determine a current repetition error image from a current error image and an earlier repetition error image, wherein the current error image is determined from the image currently captured from a value document, and the earlier repetition error image has been determined from error images which were determined from images of value documents that were captured before the currently captured image. In this way, an existing repetition error image, which was obtained from images captured in the past of different value documents and from error images derived therefrom, after the capture of a respective current image of a value document, i.e., of an image of a further value document, is updated by the error image being virtually computed with the previously existing repetition error image from the current image, whereby a new, current repetition error image is obtained. In this way, uniform errors can be determined particularly quickly, easily, and reliably.

Preferably, a user interface is provided which is designed to reproduce the determined positions of the pixels at which a plurality of the images captured from the different value documents deviate from the predefined reference image, or the at least one repetition error image. Preferably, the user interface has a display device, e.g., a monitor or a display, on which the determined positions, the repetition error image, or the corresponding positions of the deviation pixels are reproduced. Preferably, the determined positions, the repetition error image, or the corresponding positions of the deviation pixels together with an image captured from the value document—more particularly together with the image last captured from a value document—are reproduced and/or superimposed on the captured image, so that an operator can immediately assign the positions of the uniform errors in the value document(s).

Alternatively or additionally, a control device can be provided which is designed to control processing, and more particularly sorting, of the value documents as a function of the determined positions of the pixels at which a plurality of the captured images of the different value documents deviate from a predefined reference image, or as a function of the at least one repetition error image. For example, it is thereby possible to output the value documents into different sorting compartments depending upon the respectively determined uniform error. Alternatively, however, it can also be provided to output value documents having a plurality of different uniform errors into a specific sorting compartment. As an alternative or in addition to the control of the sorting of the value documents, it can also be provided—in the case of a determination of uniform errors which occur only during the checking and are not present on the value documents themselves—to carry out an adaptation of the checking software that takes into account the ascertained uniform errors—for example, by changing comparison or threshold values. Alternatively or additionally, the storage of raw data recorded by the optical inspection system can be performed in order to enable a later, computer-assisted checking of the banknote images.

Further advantages, features, and possible applications of the present invention will become apparent from the following description in conjunction with the figures. In the figures:

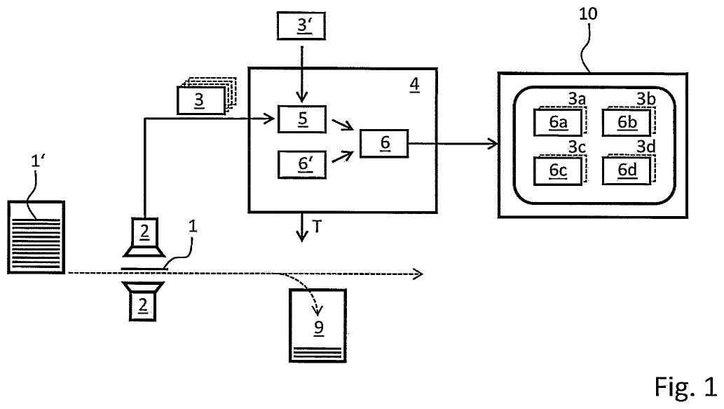

FIG. 1 shows an example of an apparatus for checking banknotes in a schematic representation;

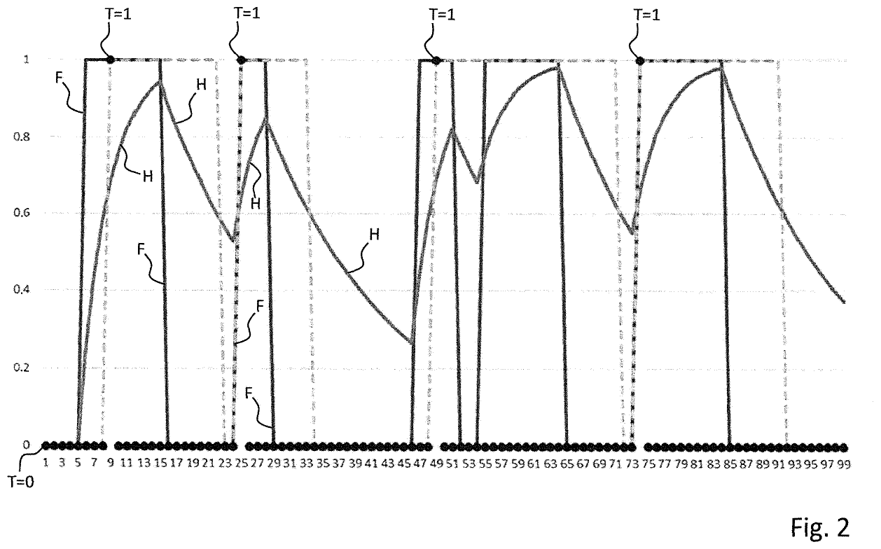

FIG. 2 shows an example of a temporal progression of the respective pixel values of a single pixel (error pixels F, deviation pixels, or “heat” H and trigger T);

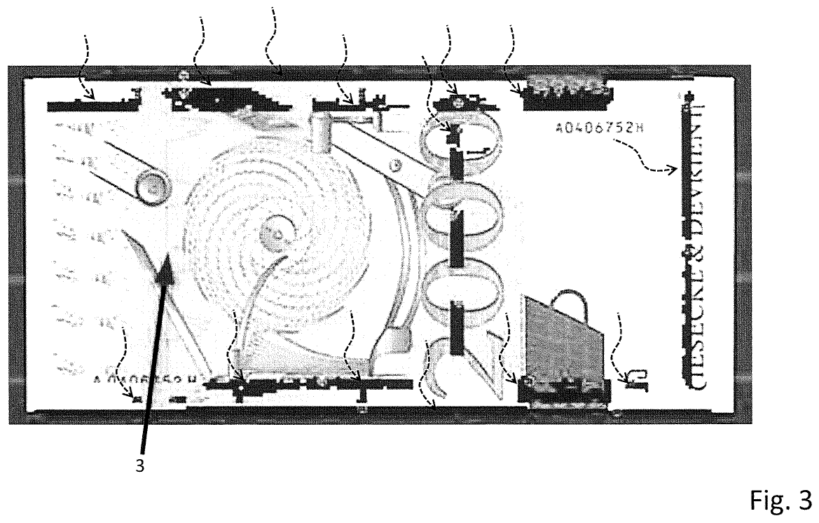

FIG. 3 shows an example of a repetition error image; and

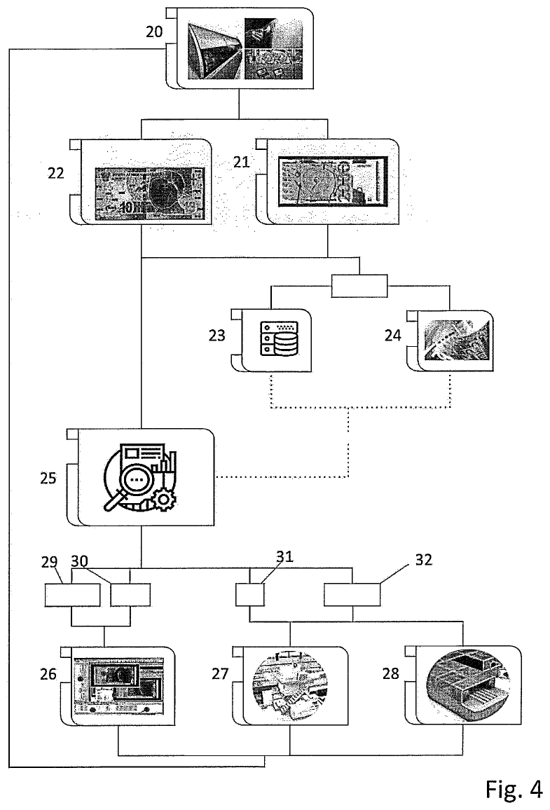

FIG. 4 is a diagram for exemplary illustration of a sequence during the checking of banknotes—more particularly in connection with quality assurance in the production of banknotes.

In the following description, in conjunction with the figures, aspects of the present disclosure are explained by way of example with reference to the checking or processing of banknotes. However, these apply accordingly for all types of value documents—for example, coupons, vouchers, checks, or chip cards.

FIG. 1 shows a schematic illustration of an example of an apparatus for checking banknotes with an image-capturing device 2, which in the present example is designed to capture at least one image 3 of each of a plurality of banknotes 1, said images being composed of a plurality of pixels, which banknotes in the present example are provided in a stack l′.

Depending upon the type, arrangement, and/or number of the cameras contained in the image-capturing device 2, a color image (RGB) and/or an infrared image (IR) and/or a transmission image can be captured from each of the front side and/or rear side of a banknote 1. for example. The present example shows an image-capturing device 2 with two cameras, which are arranged opposite one another on both sides of the transport path along which the banknotes 1 are transported. It is of course possible to provide only one camera, or else one or more further cameras.

The apparatus further has an evaluation device 4, which is designed to determine in the captured images 3 of different banknotes 1 the positions of pixels, at which the different banknotes 1 or the captured images 3 frequently or repeatedly deviate from comparison or reference values of the banknotes 1—more particularly from a predefined reference image 3′ (in the case of a plurality of cameras, a plurality of reference images 3′ are preferably predefined). A repetition error image 6 obtained in this case, which is also referred to as a “heat map” in connection with the present disclosure, shows accordingly the positions of frequently occurring or recurring image errors, wherein in each case a pixel value is assigned to the positions, which is also referred to as “heat” in connection with the present disclosure and whose value, rise, or decrease represents a measure of the frequency of occurrence of an error at the relevant position. Typically, such a heat map 6 displays errors which occur frequently or repeatedly during a checking of 100 to 300 banknotes. However, such a heat map can also be determined on the basis of the captured images of less than 100 or else more than 300 banknotes.

Preferably, an error image 5 is first determined in the evaluation device 4 on the basis of a captured image 3 of a banknote 1, which error image is also referred to as a “defective image,” by, for example, dividing the pixel values of the respectively captured image 3 with the corresponding pixel values of a reference image 3 and/or subtracting the pixels values from one another, but the pixel values of the error image 5 can also be determined by other methods or calculation methods. The pixels of the error image 5 show both the position and the extent to which the captured image 3 in the relevant position deviates from the reference image 3′.

The evaluation device 4 is preferably designed to determine the repetition error image 6 on the basis of a plurality of error images 5 which were determined from captured images 3 of a plurality of banknotes 1. Preferably, the evaluation device 4 is designed to update an already present repetition error image 6′, which was determined on the basis of previously captured images 3 of banknotes 1 or error images 5 determined therefrom, taking into account an error image 5 of a banknote 1 which has not yet been taken into account when determining the already present repetition error image 6′. In this embodiment, the repetition error image 6 is preferably updated every time when or after an image 3 of a further (previously not checked) banknote 1 has been captured, and a corresponding error image 5 has been determined therefrom. This will be explained in more detail further below.

If the image-capturing device 2 has two or more cameras which each capture an image 3 of the banknote 1, e.g., one RGB image and one IR image each per side and optionally a transmission image (i.e., a total up to five different images 3 per banknote 1), an error image 5 is preferably determined in the evaluation device 4 for each one of the different images 3 of the banknote 1. Correspondingly, different repetition error images 6 are determined from the different error images 5 which were determined for a plurality of different banknotes 1. In the aforementioned example with a total of up to five different images 3 per banknote 1, a total of up to five different repetition error images 6 are thus obtained.

The at least one repetition error image 6, which is preferably updated on the basis of the last captured image 3 or error image 5 of a banknote 1, is forwarded—preferably together with the last captured image 3 of the banknote 1—to a user interface 10, e.g., a display or a screen of a computer, and is reproduced there. In the present example, a total of four repetition error images 6a through 6d, which were obtained on the basis of one RGB image and one IR image each from the front and rear side of the banknotes, are reproduced. Optionally, the repetition error images 6a through 6d or the pixel values contained therein together with the respectively captured image 3a through 3d of a banknote can be displayed as a background in order to be able to locate the displayed uniform errors on the banknotes easily.

The evaluation device 4 is preferably designed to control a sorting of the banknotes 1. Thus, for example, a trigger signal T can be generated, by means of which an output of banknotes 1 into a special sorting compartment 9 is triggered, for which the repetition error image 6 or the pixel values contained in the repetition error image 6 exceed or fall below predefined threshold values.

The trigger signal T can also be used to store the repetition error image 6 digitally on a memory unit—for example, a hard disk or a memory card.

Preferably, the heat map 6 is determined by means of a two-fold exponential smoothing—a type of sliding average value or sliding mean—as follows: at a specific pixel position in an error image 5, the new heat (pixel value) hₙ is calculated for a banknote n from the last heat hₙ₋₁ of a most recently determined heat map 6′ as follows:

$${h}_{n} = MAX ( \frac{1}{{M}_{1}} {d}_{n} + \frac{{M}_{1} - 1}{{M}_{1}} {h}_{n - 1} , \frac{1}{{M}_{2}} {d}_{n} + \frac{{M}_{2} - 1}{{M}_{2}} {h}_{n - 1} )$$

where dₙ is the defect at this pixel position for the banknote n, and M₁ and M₂ control the rise and descent behavior. Assuming that M₁<M₂, the heat increases faster, the smaller M₁ is. The greater M₂ is, the more slowly the heat drops.

Preferably, a trigger is provided, by means of which a special sorting for banknotes is triggered in which the heat map values exceed a threshold value for one or more pixels. Preferably, the trigger is characterized by one or more of the following properties or actions:
triggering (special sorting) when a first threshold value s is exceeded.
no re-triggering before the heat has dropped below a second, lower threshold value r.
triggering one time per defective region (which usually consists of a plurality of pixels), wherein a renewed triggering by neighboring pixels (within the same defect range) is suppressed.

The trigger can, for example, be calculated or set as follows:

Starting values:

$${A}_{0} = 0 ; {B}_{0} = 0$$

A₀ and B₀ are binary images
Heat map H₀=0
Heat map H₀ is a non-binary image.

For a banknote n, the following loop is carried out:
1. Preparation: deleting the trigger pixels when the heat falls below the threshold value r.
2. Calculation of the heat map (i.e., of the heat hₙ for the pixel positions) for banknote n according to the above formula.

$${H}_{n} = f ( {H}_{n - 1} , {d}_{n} )$$

Hₙ is a non-binary image
dₙ is the defect in this pixel position
3. Checking with respect to the threshold value s:

$${T}_{n} = {H}_{n} > S$$

T. is a binary image
4. Aggregation of old and new trigger pixels:

$${A}_{n} = {T}_{n} ‖ {B}_{n - 1}$$

Aₙ is a binary image
5. Checking of new triggers in relation to previous triggers, taking into account a region around already triggered pixels.
6. Setting banknote triggers:

$$Trigger = max ( {T}_{n}^{′} ) > 0$$

FIG. 2 shows an example of a temporal progression of the respective pixel values of a single pixel (error pixel: F (solid darker line), deviation pixels or “heat”: H (solid lighter line) and trigger: T (points)) and periods in which H>s (dashed light line) for M₁=4, M₂=16, and s=r=0.6.

In the diagram shown, for illustration purposes, the number (1 to 99) of the banknote checked at the different times is indicated along the abscissa instead of time.

As can be seen from the progression of the error pixel values F, a defect is determined for the pixel in the respectively captured image of banknotes 6 through 15, as a result of which the heat H determined after each captured image rises successively, and, when the threshold value s=0.6 is exceeded in the case of banknote no. 8, the trigger T (which until then had the value 0) is set to the value 1.

Because the defect is still present up to banknote no. 15, the heat H continues to rise up to banknote no. 15, but without a trigger T being set to value 1; the trigger T assumes its starting value 0 again in this period.

In the absence of a defect for the pixel in the images of the banknote nos. 16 through 24, the heat H falls continuously and falls below the threshold r=0.6 in the case of banknote no. 22.

Only after a renewed occurrence of a defect in banknote nos. 25 through 28 (see the further progression of the pixel values F) does the heat H rise again and, in the case of banknote no. 25, exceed the threshold value s=0.6 again, so that the trigger T is again set to the value 1.

The above explanations apply accordingly for the further progression of the pixel values F, H, and T.

Preferably, the apparatus or evaluation device 4 is designed such that an operator has the possibility of predefining or modifying the values for the parameters M₁, M₂, s, and r. It is preferably assumed here that the values can be in the following ranges:
M₁: 2 to 4
M₂: 128 to 1,024, with M as a multiple of 2
s, r: 0 to 1, where s≥r.

Preferably, the configuration is set per denomination and is the same for all image-capturing devices 2 or all sensors or cameras of the image-capturing device 2.

Preferably, the configuration takes place via the user interface 10—for example, via a corresponding dialog or a corresponding dialog box.

Furthermore, it can be provided that standard values for the configuration be stored in an initialization file and be able to be changed if necessary by an operator, and more particularly a specially trained expert.

FIG. 3 shows an example of a visual representation of a repetition error image (heat map) on the user interface 10. In the present example, the heat map is superimposed on an image 3 of the banknote serving as a background—for example, an RGB image of the rear side. In order for the heat map to be significantly raised from the background, the image 3 of the banknote displayed in the background can be colored, e.g., in sepia, or displayed as a grayscale image.

The pixels contained in the heat map identify regions (see curved dashed arrows) in which recurring errors or uniform errors occur in the checked banknotes. These errors can be in the print image, in the region of security elements, or else in the region of the edges of the banknote, as is illustrated by way of example in the present example.

Preferably, the deviation pixels or heats contained in the heat map can be represented, depending upon their strength (i.e., the frequency of the occurrence of the corresponding defects at the respective pixel position), with different colors—for example, from blue to red.

On the user interface 10, a viewing option can preferably be provided in which only banknotes for which the heat map trigger was set to the value 1 are displayed.

Furthermore, the user interface 10 may be configured such that, by means of a command, such as “Analyze folder,” the banknotes listed in a folder can be analyzed in more detail. For example, for each checked banknote, it is possible to indicate whether it was classified as “unfit” or “fit,” and whether a heat map trigger was set. For example, such entries can appear as follows:

$$banknote no . n unfit + heat map trigger \\ banknote no . n + 1 \\ fit + heat map trigger$$

Preferably, a sorting function can be provided for such a list, so that all entries regarding banknotes for which the heat map trigger was set can be displayed in succession.

Preferably, for each checked banknote, the at least one heat map is stored (i.e., an image with all the heat maps for each sensor or each camera), and preferably additionally together with meta information—for example, whether a trigger has been triggered by the heat map for this banknote and for which sensor this was done.

Preferably, banknotes which have become of interest or conspicuous based upon the heat map can be redirected to specific stackers for subsequent analysis.

Preferably, the banknote data of the captured banknotes (“samples”) are saved in memory, and a “sample log” is created. This log can be used, where applicable, together with reports (“machine reports”) of the banknote processing system for an initial evaluation of the banknotes—for example, with regard to production errors. If anomalies are detected in the reports, the individual banknotes concerned can be determined, and then analyzed physically or manually or using suitable software.

In summary, it is to be noted that the present disclosure makes it possible to recognize and analyze frequently or repeatedly or continuously occurring errors in banknotes and/or, during the banknote checking, to do this as early as possible. As a result, conclusions can be drawn on a timely basis for the optimization and improvement of the production process (e.g., printing, cutting) and/or the adaptation of the checking software. By contrast, in practice heretofore, such uniform errors have not been detected or were detected only late, which generally resulted in higher reject rates in banknote production.

FIG. 4 shows an example of a flowchart for illustrating a sequence in the examination of banknotes—more particularly in connection with quality assurance in the production of banknotes.

Based upon the captured images of the banknotes during a processing (20) of freshly-printed banknotes in a banknote processing system, systematic or recurring errors in the banknotes are recognized by determining and visually reproducing a heat map (21), which preferably shows the position and frequency of image errors on the most recently processed banknotes (e.g., the last 100 banknotes) with pixel-level precision. Optionally, additional production statistics on the frequency of errors on the banknote are determined, e.g., at the end of the production of a batch of banknotes or at the end of a shift, and displayed (22).

Furthermore, the captured images of the banknotes are saved in memory (23), and/or conspicuous banknotes—more particularly in cases in which a trigger is set via the heat map—are provided for a possible manual follow-up check (24)—for example, by outputting into a special sorting compartment.

Because there are generally different types of incidents which lead to recurring image errors, there is fundamentally the possibility of backing up various types of production information in order to ensure optimal analysis of these incidents. This is achieved by the above-described adjustable trigger, which is linked to the heat map and initiates the saving of the required information in memory. Preferably, the following options are available:
a) saving raw data of the image-capturing device (cameras, sensors) in memory
b) saving heat maps in memory
c) physical examination of banknotes
d) displaying incidents on the basis of machine reports

Based upon this information, the machine operator can easily recognize and analyze, in real time, recurring image errors on the banknotes (25) and report these incidents as early as possible and/or continuously to those responsible for production, so that there is immediately or continuously a fine tuning or post-adaptation of the checking software (26) there, which improves printing processes (27), and/or the process(es) involved in the cutting of the banknotes can be improved (28). The information generated by the heat map can help, for example, quality engineers and/or printing machine operators better than before to optimize the overall quality and production statistics.

In the analysis (25) of the incidents or data, it is possible to more easily and more reliably identify the banknotes which are incorrectly classified as “unfit” (29) or incorrectly classified as “fit” (30) due to insufficient adaptation of the checking software, and to better understand the causes of the incorrect classification. Accordingly, in such cases, primarily a fine tuning or post-adaptation of the checking software (26) is initiated.

The analysis (25) of the incidents or data can, further, help identify banknotes classified as “fit” (31) which are close to the threshold values of “unfit” banknotes, but have a sufficiently good quality. Ultimately, it is also possible to determine the errors identified in the images that are attributable to the printing and/or cutting, whereupon the printing process (27) or cutting process (28) is adapted.

1.-11. (canceled)

12. An apparatus for checking value documents, and more particularly banknotes, having at least one image-capturing device, which is designed to capture at least one image of each of a plurality of value documents, said images each being composed of a plurality of pixels,
wherein an evaluation device, which is designed to determine, in the captured images of different value documents, one or more positions of pixels at which a plurality of the captured images of the different value documents deviate from a predefined reference image.

13. The apparatus according to claim 12, wherein the evaluation device is designed to:
determine, from the captured images of different value documents, in each case an error image, which contains one or more error pixels, at the positions of which the captured image of the respective value document deviates from the reference image, and
determine from the error images a repetition error image that contains one or more deviation pixels whose positions correspond to the positions of error pixels at which a plurality of the captured images of the different value documents deviate from the reference image.

14. The apparatus according to claim 13, wherein the evaluation device is designed to determine in each case a deviation pixel value for the deviation pixels taking into account a frequency with which the corresponding positions of error pixels are contained in the error images.

15. The apparatus according to claim 13, wherein the evaluation device is designed to determine in each case a deviation pixel value for the deviation pixels by means of exponential smoothing and/or by form a sliding average from the error pixels contained in the error images.

16. The apparatus according to claim 13, wherein the evaluation device is designed to determine a current repetition error image from a current error image and a previous repetition error image,
wherein the current error image is determined from the currently captured image of a value document, and the previous repetition error image was determined from error images which were captured from images of value documents which were captured before the currently captured image.

17. The apparatus according to claim 12, having a user interface which is designed to reproduce the determined positions of the pixels at which a plurality of the captured images of the different value documents deviate from the predefined reference image, or the at least one repetition error image.

18. The apparatus according to claim 12, having a control device which is designed to control processing, and more particularly sorting, of the value documents as a function of the determined positions of the pixels at which a plurality of the captured images of the different value documents deviate from a predefined reference image or as a function of the at least one repetition error image.

19. A system for processing value documents, and more particularly banknotes, having at least one apparatus for processing, and more particularly separating, conveying, and/or sorting, value documents and at least one apparatus for checking value documents according to claim 12.

20. A method for checking value documents, and more particularly banknotes, in which at least one image of each of a plurality of value documents is captured, said images each being composed of a plurality of pixels,
wherein, in the captured images of different value documents, one or more positions of pixels at which a plurality of the captured images of the different value documents deviate from a predefined reference image are determined.

21. A computer program product comprising commands which, when the program is executed by a computer, cause the computer to carry out the method according to claim 20.

22. A computer-readable storage medium comprising commands which, when executed by a computer, cause the computer to carry out the method according to claim 20.
